(19) United States
(12) Patent Application Publication
(10) Pub. No.: US 2026/0342883 A1
(43) Pub. Date: Oct. 29, 2026

(54) INFORMATION PROCESSING METHOD AND APPARATUS, AND ELECTRONIC DEVICE

(71) Applicant: Beijing Zitiao Network Technology Co., Ltd., Beijing (CN)

(72) Inventors: Zhong WANG, Beijing (CN); Fengjuan SHI, Beijing (CN); Chao ZHANG, Beijing (CN); Jiachen ZHAO, Beijing (CN); Liuyuan YU, Beijing (CN); Li XIONG, Beijing (CN); Tingsheng SHI, Beijing (CN)

(21) Appl. No.: 19/107,021

(22) PCT Filed: Feb. 19, 2024
(86) PCT No.: PCT/CN2024/077578

§ 371 Date: Feb. 26, 2025

(30) Foreign Application Priority Data
Feb. 28, 2023 (CN) 202310215689.9

(51) Int. Cl. H04L 67/141; H04L 67/143

(52) U.S. Cl. CPC H04L 67/141; H04L 67/143

(57) ABSTRACT

Provided in the embodiments of the present disclosure are an information processing method and apparatus, and an electronic device. The method includes: creating a target component according to a received session component creation request, wherein the session component creation request includes a target session identifier and address information of service data; acquiring the service data according to the address information; instantiating the target component according to the service data; and displaying a target component instance in a session interface indicated by the target session identifier.

### CROSS-REFERENCE TO RELATED APPLICATION

This application claims priority to Chinese Patent Application No. 202310215689.9, filed on Feb. 28, 2023, the disclosure of which is incorporated herein by reference in its entirety.

### TECHNICAL FIELD

Embodiments of the present disclosure relate to an information processing method and apparatus, and an electronic device.

### BACKGROUND

With the development of communication technology, users can use instant messaging applications for information communication. The user may deploy multiple sessions by using the instant messaging application, and may have information communication in real time with at least one contact in a session.

Messages in a session are typically displayed in the session in chronological order of generation.

Session-related users may all focus on the same information. The above-mentioned information may be information other than the content of the session, such as information from a third-party platform. When viewing the above-mentioned information, each user needs to open a page provided by the third-party platform, and then browse the above-mentioned information on the above-mentioned page.

In particular, the operation of a user in a session to acquire the above-mentioned information is complicated. It is not conducive for users to quickly acquire information of interest, and therefore, session users are less efficient in acquiring out-of-session information.

### SUMMARY

Embodiments of the present disclosure provide an information processing method and apparatus, and an electronic device to overcome the problem that users corresponding to a session are less efficient in acquiring information of common interest.

In a first aspect, embodiments of the present disclosure provide an information processing method, including:
creating a target component according to a received session component creation request, where the session component creation request includes a target session identifier and address information of service data;
acquiring the service data according to the address information;
instantiating the target component according to the service data; and
displaying a target component instance in a session interface indicated by the target session identifier.

In a second aspect, embodiments of the present disclosure provide an information processing method, including:
displaying a component container in a display interface of a target session; and
displaying, in the component container, at least one component instance including a target component instance; where the target component instance includes preset service data.

In a third aspect, embodiments of the present disclosure provide an information processing method, including:
generating a session component creation request, where the session component creation request includes address information of service data and an identifier of a target session;
sending the session component creation request to a session server of the target session, so that the session server creates a target component; and
sending the service data to the session server; so that the session server generates a target component instance according to the service data.

In a fourth aspect, embodiments of the present disclosure provide an information processing apparatus, including:
a creation unit, configured to create a target component according to a received session component creation request, where the session component creation request includes a target session identifier and address information of service data;
an acquisition unit, configured to acquire the service data according to the address information;
an instantiation unit, configured to instantiate the target component according to the service data; and
a first display unit, configured to display a target component instance in a session interface indicated by the target session identifier.

In a fifth aspect, embodiments of the present disclosure provide an information processing apparatus, including:
a second display unit, configured to display a component container in a display interface of a target session; and
a third display unit, configured to display, in the component container, at least one component instance including a target component instance; where the target component instance includes preset service data.

In a sixth aspect, embodiments of the present disclosure provide an information processing apparatus, including:
a generating unit, configured to generate a session component creation request, where the session component creation request includes address information of service data and an identifier of a target session;
a first sending unit, configured to send the session component creation request to a session server of the target session, so that the session server creates a target component; and
a second sending unit, configured to send the service data to the session server, so that the session server generates a target component instance according to the service data.

In a seventh aspect, embodiments of the present disclosure provide an electronic device including: a processor and a memory; where the memory stores computer-executable instructions; the processor executes the computer-executable instructions stored in the memory so as to realize the information processing method as described in the above-mentioned first aspect, second aspect and third aspect, and possibly involved in the above-mentioned various aspects.

In an eighth aspect, embodiments of the present disclosure provide a computer-readable storage medium including computer-executable instructions stored thereon, where the computer-executable instructions, when executed by a processor, are configured to realize the information processing method as described in the above-mentioned first aspect, second aspect and third aspect, and possibly involved in the above-mentioned various possible aspects.

In a ninth aspect, embodiments of the present disclosure provide a computer program product including a computer program which, when executed by a processor, is configured to realize the information processing method as described in the above-mentioned first aspect, second aspect and third aspect, and possibly involved in the above-mentioned various possible aspects.

### BRIEF DESCRIPTION OF DRAWINGS

In order to more clearly illustrate the technical solutions of the embodiments of the present disclosure, a brief description will be given below with reference to the accompanying drawings which are required to be used in the embodiments. It is obvious that the drawings in the following description are some embodiments of the present disclosure, and it would have been obvious for a person of ordinary skill in the art to obtain other drawings according to these drawings without involving any inventive effort.

FIG. 1 is a first schematic flowchart of an information processing method provided by an embodiment of the present disclosure;

FIG. 2 is a second schematic flowchart of an information processing method provided by an embodiment of the present disclosure;

FIG. 3 is a third schematic flowchart of an information processing method provided in accordance with the present disclosure;

FIG. 4A is a schematic diagram of a session interface for a target session provided in accordance with the present disclosure;

FIG. 4B is a schematic diagram of a session interface for a target session provided in accordance with the present disclosure;

FIG. 4C is a schematic diagram of a session interface for a target session provided in accordance with the present disclosure;

FIG. 5 is a fourth schematic flowchart of an information processing method provided in accordance with the present disclosure;

FIG. 6 is a principle flowchart of an information processing method provided in accordance with the present disclosure;

FIG. 7 is a block diagram of structure of an information processing apparatus provided by an embodiment of the present disclosure;

FIG. 8 is a block diagram of structure of an information processing apparatus provided by an embodiment of the present disclosure;

FIG. 9 is a block diagram of structure of an information processing apparatus provided by an embodiment of the present disclosure; and

FIG. 10 is a schematic diagram of hardware structure of an electronic device provided by an embodiment of the present disclosure.

### DETAILED DESCRIPTION

In order to enable the objects, aspects, and advantages of the embodiments of the present disclosure to become more apparent, the technical solutions in the embodiments of the present disclosure will be described clearly and completely in connection with the accompanying drawings in the embodiments of the present disclosure. Apparently, the described embodiments are part of the embodiments of the present disclosure, rather than all of the embodiments. Based on the embodiments in the present disclosure, all other embodiments obtained by a person of ordinary skill in the art without inventive effort fall within the scope of protection of the present disclosure.

In an instant messaging application, a session typically involves at least two users. Detail information of the session may be displayed in a session interface, for example, displaying at least one message of a session user, etc.

In addition to information communication with other session users, a session user may also be interested in some information from third-party platforms.

If a session user needs information from the third-party platform, the session user has to enter a page of the third-party platform and then browse the above-mentioned information on the page. For a plurality of users in the session who focus on the information, the plurality of users need to respectively open a page of the above-mentioned third-party platform by using respective terminal devices to browse the above-mentioned information. In this way, the session user would take a longer total time to acquire the above-mentioned information, which results in poor, overall efficiency for the session user to acquire the above-mentioned information.

In order to alleviate the above-mentioned problem, the present disclosure provides the technical solution as below: generating a target component instance according to service data other than a session message by creating a target component corresponding to a session, and displaying the target component instance in a session interface, so that all the users of the session can browse the above-mentioned service data in the session interface, and the efficiency for the session users to acquire the service data other than the session message can be improved.

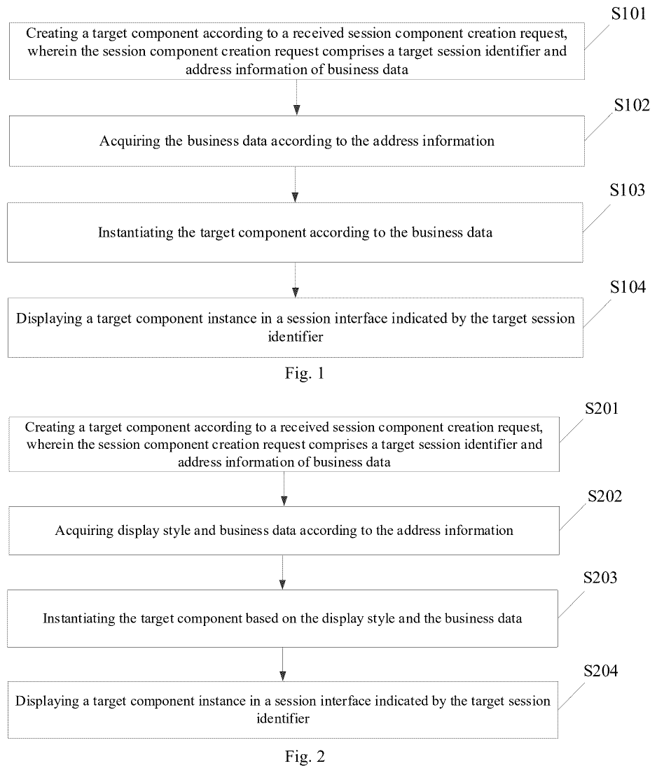

Referring to FIG. 1, FIG. 1 is a first schematic flowchart of an information processing method provided by an embodiment of the present disclosure. The method includes:
S101: creating a target component according to a received session component creation request, where the session component creation request includes a target session identifier and address information of service data.

The execution body of the information processing method of the present embodiment may be a session server (also referred to as an instant messaging application server). For example, a server that provides message relay and message storage for parties to a session.

In addition, the above-mentioned session server may provide, to the client, display layout information of each element in the session interface.

In the present embodiment, the above-mentioned display layout information provided to the client by the session server includes information of component container.

A plurality of components can be managed separately by using the above-mentioned component container. For a component container to which components have been associated, the above-mentioned server may set, for each component, a display position in the above-mentioned component container. Each component (e.g., Widget component) is independent of other components and does not interfere with other components.

The above-mentioned session component creation request is used to create, for a target session, a component displayed on the session interface. The target session here may be a variety of sessions, such as a single chat session, a group chat session, etc. The component to be created may be referred to herein as the target component.

The above-mentioned session component creation request includes a target session identifier and address information of service data.

The target session identifier may include texts, letters, or symbols, etc. The session identifier can distinguish different sessions.

The service data here may be data that is of interest to the majority of the session users in the target session. The service data here may be data other than session messages, e.g., data from a third-party platform.

Illustratively, the service data herein may include real-time stock market quotation data, for example.

Illustratively, the service data herein may be real-time game situation data or the like.

Illustratively, the service data herein may be real-time inventory data or the like.

Service data herein may include texts, graphics, images, tables, etc.

The above-mentioned address information refers to address information stored in the service data. The above-mentioned address information may include, for example, a Uniform Resource Locator (URL).

The above-mentioned execution body may acquire the service data from the address indicated by the address information.

In the present embodiment, the above-mentioned session component may be various components. In some embodiments, the above-mentioned component may be, for example, a micro-component (Widget component).

By using micro-components, user requirements such as a simple, clear and appropriate presentation as well as personalized customization can be satisfied.

A micro-component may be a structured description of a view that primarily stores configuration information of the rendering of the view, including layout, rendering properties, and event response information. Generally, a micro-component has main constituents of a limit box, a frame, a Widget graphical control and other elements.

In some embodiments, a session component creation request herein may be issued by a session user through a client which is used for conducting a session by the session user. The above-mentioned client may be operated in a terminal device. The above-mentioned client may be an instant messaging application client.

In some embodiments, the session component creation request herein may be issued by a server of the service data of interest to the session user.

In these embodiments, the service data server may actively send the above-mentioned session component creation request to the session server.

In some embodiments, the above-mentioned step S101 includes:
Firstly, receiving a session component creation request sent by a service data server via a component creation interface;
Secondly, creating a target component by using a component addition interface.

In these embodiments, the above-mentioned execution body may provide a component creation interface, such as a micro-component creation interface (CreatWidget). The service data server may send a session component creation request to the session server by using the above-mentioned component creation interface. For example, the service data server locally invokes a component creation interface provided by the session server, and parameters such as address information of service data and the type of target component are input in the component creation interface.

The session server may create a target component based on a component addition interface (e.g., a micro-component addition interface AddChatWidgets) provided by a local side of the session server.

In these embodiments, the session server may receive, via a component creation interface, a session component creation request sent by the service data server, and create a target component by using a component addition interface; namely, the session server may create the target component by using a component processing function provided in advance at the local side of the session server, so that the speed of creating the target component may be increased.

In some embodiments, the above-mentioned step S101 includes: creating a target component abstraction instance according to the session component creation request.

In these embodiments, the above-mentioned execution body, upon receiving the above-mentioned session component creation request, may firstly create a target component abstraction instance according to preset abstraction instance creation rules.

A limit box, a frame, a basic control and the like of the target component may be included in the target component abstraction instance.

In these embodiments, a target component instance can be obtained after filling service data into an abstraction instance of the target component; or the target component instance can be obtained after filling service data into the abstraction instance of the target component according to a specified display style.
S102: acquiring the service data according to the address information.

The above-mentioned address information may include a storage address of service data, for example, an address of a standard resource of the service data on the Internet: URL. For URL, a schema (or protocol), a server name (or IP address), a path, and a file name, such as “Protocol://Authorization/Path?Query”, can be typically included. A more complete example for URL is illustrated below: Protocol://User name: Password@Subdomain Name. Domain Name. Top Domain Name: Port Number/Directory/File Name. File Suffix?Parameter=Value # flag.

The above-mentioned execution body may acquire the service data from the service data server according to the above-mentioned address information through a wired or wireless communication connection.
S103: instantiating the target component according to the service data.

After acquiring the above-mentioned service data, the target component can be instantiated by using a preset component instantiation method. In the process of instantiating a target component, service data is filled into the above-mentioned target component. In one example, the service data may be bound to an element in the target component that is preset to carry the above-mentioned service data. Rendering information for each element of the target component is then generated. A target component instance is thus obtained.
S104: displaying a target component instance in a session interface indicated by the target session identifier.

Here, the session interface may be a session interface of the target session indicated by the target session identifier. Here, the session interface may be a session interface corresponding to at least one session user of the above-mentioned target session.

In the present embodiment, the above-mentioned execution body may send the above-mentioned target component instance to a respective client (e.g., an instant messaging application client) corresponding to a respective session user of the target session, so that the client displays the above-mentioned target component instance in a session interface of the target session.

In practice, session messages and target component instances of the target session may be displayed in the above-mentioned session interface.

The above-mentioned target component instance may be displayed in a component container of the session interface.

In the present embodiment, a target component is created according to a received session component creation request, and the session component creation request includes a target session identifier and address information of service data; the service data is acquired according to the address information; a target component is instantiated according to the service data; and a target component instance is displayed in a session interface indicated by the target session identifier. It achieves creating a session component in a session, instantiating the component by using service data and displaying the component instance in a session interface corresponding to a session user, so as to display, in the session interface, by means of the component, service data of interest to the session user other than the session message. The operation of a session user for acquiring third-party service data is reduced, and the efficiency for the session user to acquire the above-mentioned service data is improved.

Referring to FIG. 2, FIG. 2 is a second schematic flowchart of an information processing method provided by an embodiment of the present disclosure. The method includes:
S201: creating a target component according to a received session component creation request, where the session component creation request includes a target session identifier and address information of service data.

In the present embodiment, the execution body of the information processing method may be a session server.

The specific implementation of step S201 and step S204 may refer to step S101 and step S104 of the embodiment shown in FIG. 1, which will not be described in detail.
S202: acquiring a display style and the service data according to the address information.

The service data and the display style of the service data may be stored in the service data server. The above-mentioned address information may include a uniform resource locator corresponding to a physical address storing the display style and the service data.

The above-mentioned display style may be a display style of the service data. The display style includes, but is not limited to: background color, number of windows, window size, window layout, text/symbol color, text/symbol size, font, image/graphic size, etc.

The above-mentioned execution body may acquire the display style and the service data from the service data server according to the above-mentioned address information.
S203: instantiating the target component based on the display style and the service data.

By using an instantiation method, the above-mentioned execution body can instantiate the service data on the target component according to the above-mentioned display style, thereby obtaining a target component instance.
S204: displaying a target component instance in a session interface indicated by the target session identifier.

In the present embodiment, the above-mentioned service data server provides a display style for displaying the service data, thus the session server does not need to determine the above-mentioned display style of the service data, thereby simplifying the step of generating the target component by the session server, reducing the resource consumption of generating the target component by the session server, improving the speed of generating the target component by the session server, and further improving the overall efficiency of the process from generating the target component to displaying the target component instance in the session interface of the target session.

In some embodiments of the information processing method shown in FIG. 1 and FIG. 2, the above-mentioned information processing method further includes:
Firstly, creating a preview identifier corresponding to the target component, and associating the preview identifier with the address information.
Secondly, sending the preview identifier to a client of a user of the target session.

Step S102 of the embodiment shown in FIG. 1 and step S202 of the embodiment shown in FIG. 2 include:
in response to receiving a browsing request for browsing the target component instance sent by a client of a user of the target session, acquiring the service data according to the address information; where the browsing request includes the preview identifier.

In these embodiments, the above-mentioned execution body may generate a preview identifier (PreviewID) of the target component after creating the target component (target component abstraction instance) according to the session component creation request. The above-mentioned execution body may associate the preview identifier with the above-mentioned address information. The preview identifier is then sent to the client displaying the target session (e.g., the instant messaging application client).

The user may initiate, at the session interface of the above-mentioned target session, a browsing operation for browsing the target component instance. The above-mentioned client can check, locally, whether a component instance matching the preview identifier is stored, and if so, binding the local component instance with the target component to generate the target component instance.

If the above-mentioned client does not find, locally, a component instance matching the preview identifier, a browsing request can be generated, and the browsing request may include the preview identifier. The client can send the above-mentioned browsing request to the session server, and if the session server does not find, locally, a component instance corresponding to the preview identifier either, it may search for the address information associated with the preview identifier. The service data is then acquired from the service data server according to the above-mentioned address information.

In these embodiments, after the target component is created, a preview identifier associated with the address information is generated, and then the preview identifier is sent to the client, so that the client acquires the service data locally or acquires the service data via the session server according to the above-mentioned preview identifier to generate a target component instance, which facilitates management of different components.

In some embodiments of the information processing method shown in FIG. 1 and FIG. 2, the above-mentioned information processing method further includes the following steps:
Firstly, acquiring updated service data and/or updated display style.
Secondly, updating the target component instance based on the updated service data and/or the updated display style.

In these embodiments, the above-mentioned execution body may send an updating information acquisition request to the service data server at preset time intervals. The service data server may detect whether the service data and/or the display style is updated according to the above-mentioned acquisition request. If it is detected that the service data and/or the display style is updated, updating information including the updated service data and/or the updated display style is generated.

After receiving the above-mentioned updated service data and/or updated display style, the above-mentioned execution body updates the target component instance according to the updated service data and/or the updated display style.

In these embodiments, the session server can acquire updated service data for the target component instance and then update the target component instance. In this way, it's advantageous for the session server to actively update the target component instance based on the service data. It is further advantageous to control the content in the target component instance displayed in the session interface of the target session.

In some embodiments of the information processing method shown in FIG. 1 and FIG. 2, the above-mentioned information processing method further includes the following steps:

In response to detecting a change in the target component instance, pushing information of the changed target component instance to the client of the user of the target session; where the above-mentioned change is generated by the updated service data and/or updated display style sent by the service data server.

In these embodiments, the above-mentioned service data server may actively detect whether the above-mentioned service data and/or the display style has been changed, for example, detecting once every preset time interval.

Upon detecting a change in at least one of the service data and the display style, the updated service data and/or updated display style may be sent to the session server. The session server updates the target component instance according to the updated service data and/or updated display style, thereby causing a change in the target component instance. The above-mentioned execution body may send information of the changed target component instance to the above-mentioned client. This information may include information indicating the service data and/or style having been updated in the target component instance, and information of the updated service data and/or updated style.

After receiving the above-mentioned information of the changed target component instance, the above-mentioned client may display the updated target component instance on the local side according to the above-mentioned information.

In these embodiments, when detecting a change in the target component instance according to the information pushed by the service data server, the session server pushes the information of the changed target component instance to the above-mentioned client, so that the above-mentioned client can display the updated target component instance, and the user of the target session can learn the latest service data in time in the session interface, which can improve the efficiency for the user to acquire the service data other than the session message.

In some embodiments of the information processing method shown in FIG. 1 and FIG. 2, the above-mentioned information processing method further includes the following steps:

According to a received deletion instruction for a session component, deleting a component in the target session indicated by the deletion instruction, and sending, to the client of the user of the target session, an instruction for instructing to delete pre-stored information of the component.

In these embodiments, the above-mentioned deletion instruction may be generated by the client of the session user based on a component delete operation issued by the session user at the session interface. The above-mentioned deletion instruction includes identifier information of the component to be deleted, such as preview identifier information of the component.

After receiving the above-mentioned deletion instruction, the above-mentioned execution body may locally delete a component instance of the component, such as a display style and service data, etc., delete a preview identifier of the component and address information associated with the preview identifier, etc., and finally delete the component.

In addition, the above-mentioned execution body may send, to the client, an instruction for instructing to delete the pre-stored information of the component. The client may delete all the locally pre-stored information of the component according to the above-mentioned instructions.

In these embodiments, the components in the target session may be deleted via the above-mentioned deletion instructions, thereby facilitating the maintenance of the components in the session.

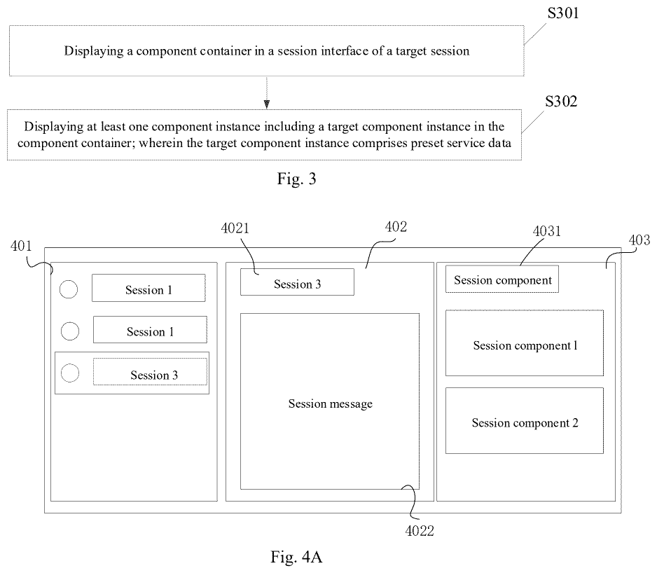

Referring to FIG. 3, FIG. 3 is a third schematic flowchart of an information processing method provided in accordance with the present disclosure. The method includes:
S301: displaying a component container in the session interface of the target session.

The execution body in the present embodiment may be a terminal device. It may in particular be a client running on the terminal device that can conduct a session, such as an instant messaging application client.

The target session here may be a variety of sessions, such as a single chat session, or a group chat session.

The above-mentioned session interface may be a session interface displaying a message of the target session, a session interface displaying a calendar of the target session, etc.

The component container herein may be pre-created for containing at least one component.

In some application scenarios, the above-mentioned component container may be created for the target session by the session server. The above-mentioned session server may associate the component container with the target session and send the component container to the above-mentioned client. The above-mentioned client displays the above-mentioned component container when displaying the session interface of the target session according to an association relationship between the target session and the component container.

In some application scenarios, the above-mentioned component container may be created by the session server based on a received, first component creation request for creating a target session.

In some application scenarios in which the above-mentioned component container may be hidden, a container display control for indicating the display of the component container may be included in the session interface of the target session. The user may trigger the above-mentioned container display control. The above-mentioned execution body can display the component container in the session interface of the target session after detecting the user's trigger operation for the above-mentioned container display control.
S302: displaying, in the component container, at least one component instance including the target component instance; where the target component instance includes preset service data.

The above-mentioned at least one component instance may be pre-generated and bound to the target session. The above-mentioned at least one component instance may have been associated with the component container in advance.

For example, the session server may create a component according to a session component creation request in advance, bind the component with the target session, generate a component instance (including rendering information for session component instance), and send the component instance to the client.

The client displays at least one component instance when displaying the above-mentioned component container.

In some application scenarios, the session interface of the target session also displays at least part of the session messages of the target session.

In one example, a session message display area and a component container display area are displayed from left to right in the above-mentioned session interface. The session message display area may display at least one session message for the target session. The above-mentioned component container display area may display a plurality of components bound to the target session.

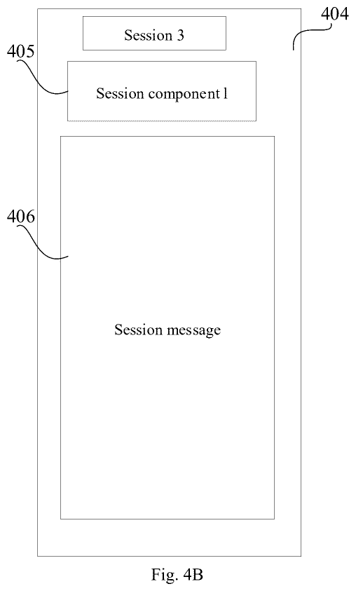

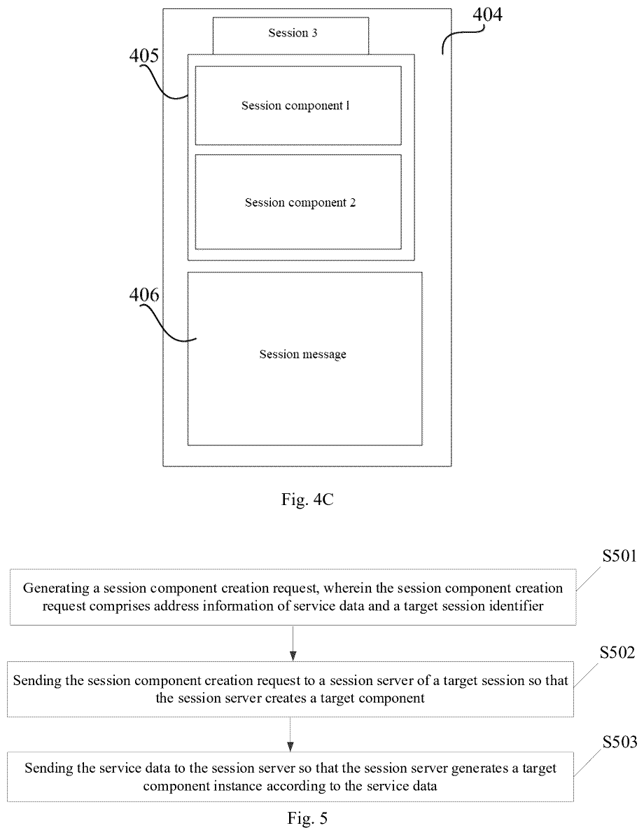

Referring to FIG. 4A, FIG. 4A shows a schematic diagram of a session interface for a target session.

As shown in FIG. 4A, a session interface for a target session may include a session flow display area 401, a session message display area 402, and a component container display area 403. As shown in FIG. 4A, the target session selected for display in the current session interface is session 3. The session message for session 3 is displayed in the session message display area 402. A component container identifier “session component” 4031 may be displayed in the component container display area 403, along with a plurality of session components, such as session component 1 and session component 2 in FIG. 4A, etc.

In some embodiments, in the above-mentioned session interface, the above-mentioned component container is displayed at the top of the session interface, and the above-mentioned step S302 includes:

In response to receiving a first display instruction for displaying a plurality of component instances, increasing a display area of the component container in the session interface and displaying the plurality of component instances in the component container.

In these embodiments, the component container is displayed at the top of the session interface by default, and at least one session message may be displayed below the component container.

Referring to FIG. 4B, FIG. 4B shows a schematic diagram of a session interface for a target session.

As shown in FIG. 4B, the current target session is session 3, and in the session interface 404 of the target session (session 3), a component container 405 is displayed at the top of the session interface 404. One session component, such as session component 1 in FIG. 4B, is displayed in the component container 405 by default. In the session interface, a session message area 406 may be displayed below the component container 405, and at least part of the session messages may be displayed in the session message area.

In one example, a pull-down control may be displayed in the above-mentioned component container; and upon receiving a trigger operation for the pull-down control executed by a user, the first display instruction may be deemed to be received.

Upon receiving the above-mentioned first display instruction, the display area of the component container in the session interface is increased, for example, the display length of the component container is extended downwardly. After the above-mentioned display area is increased, more component instances can be displayed in the above-mentioned component container.

Referring to FIG. 4C, FIG. 4C is a session interface after the first display instruction is executed for the example of FIG. 4B. As shown in FIG. 4C, according to the above-mentioned first display instruction, the display area of the above-mentioned component container 405 is increased, namely, the component container is elongated, and session components such as session component 1 and session component 2 can be displayed in the elongated component container.

In these embodiments, by displaying a single component instance, by default, at the top of the component container, the above-mentioned first display instruction may be executed when a user desires to browse multiple component instances, so that the user can browse multiple component instances in the component container with increased display area. In this way, one or more component instances may be displayed in the session interface of the target session according to the needs of the user.

The above-mentioned multiple component instances are independent of each other and do not interfere with each other.

The above-mentioned target component instance is one of the above-mentioned at least one component instance. The target component instance may be pre-created by the session server and associated with the target session and then sent to the client of the session user corresponding to the target session. Preset service data may be included in the above-mentioned target component instance. Here, the preset service data may be determined and acquired by the session server according to the received target component creation request.

The service data herein may be data that is of interest to the majority of the session users in the target session.

In one example, the service data herein may include real-time stock market quotation data, for example.

In one example, the service data herein may be real-time game situation data or the like.

In one example, the service data herein may be real-time inventory data or the like.

The above-mentioned service data may include texts, graphics, images, tables, etc.

In the present embodiment, a component container is displayed in a session interface of a target session; and at least one component instance including a target component instance is displayed in the component container; where the target component instance includes preset service data. It achieves displaying a component instance in a session interface corresponding to a session user, where the component instance includes service data, so as to display, in the session interface by means of the component, third-party service data of interest to the session user other than the session. In this way, the operation of a session user for acquiring the service data is reduced, and the efficiency for the session user to acquire the above-mentioned service data is improved.

In some embodiments, the above-mentioned information processing method further includes the steps below:
Firstly, generating a component creation instruction according to a component creation operation of a user; where the component creation operation is used for creating a target component of a target session, the component creation instruction includes identifier information of service data.

In these embodiments, the user may execute a component creation operation in the session interface of the target session. Illustratively, a component creation control for creating components may be displayed in the above-mentioned session interface. After a trigger operation executed by the user on the above-mentioned component creation control is detected, the user may also execute a selection operation for the information of the service data. The above-mentioned information of the service data includes information for uniquely representing the service data, such as address information of the service data, etc. The above-mentioned operation of a user can be regarded as a received, component creation operation of the user.

The above-mentioned execution body may generate a component creation instruction including target session information and identifier information of the service data according to the above-mentioned component creation operation.
Secondly, sending the component creation instruction to the service data server so that the service data server generates a session component creation request according to the component creation instruction and sends the session component creation request to the session server, so that the session server creates the target component.
Finally, receiving a target component instance sent by the session server, and displaying the target component instance in the session interface of the target session, where the target component instance is generated based on the service data acquired by the session server.

The above-mentioned service data server generates a session component creation request after receiving the above-mentioned component creation instruction. The session component creation request includes a target session identifier and address information of service data. The above-mentioned session component creation request is then sent to the session server. The session server may create the target component according to the session component creation request, and generate the target component instance based on the service data acquired from the service data server according to the above-mentioned address information. The session server may send the target component instance to the client of the target session such that the client displays the target component instance in the session interface of the target session.

In these embodiments, the creation of the target component may be initiated by the session user, thereby achieving the user configurability of the component, which may improve the user experience.

In some embodiments, the above-mentioned information processing method further includes:
Firstly, receiving a preview identifier of the target component sent by the session server, where the above-mentioned preview identifier is generated by the session server when the target component is created.
Secondly, in response to detecting that there is no local component instance matched with the preview identifier, sending a request for acquiring an instance to the session server, receiving a component instance sent by the session server, binding the component instance with the target component, and generating a target component instance; or
In response to detecting that there is a local component instance matched with the preview identifier, binding the component instance with the target component, and generating a target component instance.

In these embodiments, the session server, after creating the target component, may generate a preview identifier (PreviewID) of the target component. The session server may associate the above-mentioned preview identifier with the address information of the service data and the created target component, respectively. The above-mentioned session server may send the above-mentioned target component and preview identifier to the above-mentioned execution body. After receiving the above-mentioned target component and preview identifier, the above-mentioned execution body can locally detect whether there is a component instance matching the preview identifier. If a component instance matching the preview identifier is found locally, the above-mentioned component instance can be directly bound with the target component. In this way, the above-mentioned execution body obtains the target component instance.

If a component instance matching the preview identifier is not detected locally, the above-mentioned execution body may send a request for acquiring an instance to the session server. The session server can locally find whether there is a component instance matching the preview identifier, and if so, send the above-mentioned component instance to the above-mentioned execution body. If the session server does not find a component instance matching the preview identifier locally, a data acquisition request may be sent to the service data server. The above-mentioned data acquisition request may include address information of service data. After receiving the above-mentioned data acquisition request, the service data server may send the service data and/or the display style matching the preview identifier to the session server. The session server may generate the target component instance after receiving the above-mentioned service data and/or display style. The target component instance is bound with the preview identifier of the target component, and is sent to the above-mentioned execution body.

In these embodiments, the above-mentioned execution body may first check whether there is a local component instance matched with the target component, and if so, generate the target component instance by directly using the local component instance. If there is no local component instance matched with the target component, the component instance is acquired from the session server, so that a target component instance can be quickly displayed by using a locally stored component instance of the execution body. The speed of displaying the target component instance in the session interface of the target session can be improved to some extent.

In some embodiments, the above-mentioned information processing method further includes: in response to receiving an instruction for deleting a component sent by a user in a session interface of a target session, sending component deletion information for deleting the component indicated by the instruction to the session server; and locally deleting the stored information of the component.

In these embodiments, the component container is displayed in the session interface of the above-mentioned target session. At least one component may be displayed in the component container. For any component, the user may send an instruction for deleting the component. For example, a deletion control may be displayed in a display area of each component. The user can execute a trigger operation on the deletion control in the display area of the component so as to issue a component deletion instruction for the component to the above-mentioned execution body.

The above-mentioned execution body may generate component deletion information after receiving the above-mentioned component deletion instruction. The component deletion information may include a component identifier of the component indicated by the component deletion instruction. Upon receiving the above-mentioned component deletion information, the session server may destroy, in the session server, information of the service data and/or display style of the component indicated by the component identifier and the information of the component.

In addition, the above-mentioned execution body may delete locally stored information of the component, including information such as a display style and/or service data of the component.

In these embodiments, the user may delete the component indicated by the instruction at the client side as well as the session server side according to the instruction for deleting the component, thereby facilitating the user's maintenance of the component displayed in the display interface of the session.

Referring to FIG. 5, FIG. 5 is a fourth schematic flowchart of an information processing method provided in accordance with the present disclosure. The method includes:
S501: generating a session component creation request, where the session component creation request includes address information of service data and a target session identifier.
S502: sending the session component creation request to a session server of a target session, so the session server creates a target component.

In the present embodiment, the execution body of the information processing method may be a service data server.

The service data server may be a server different from the session server. The above-mentioned service data server may store different service data. In some application scenarios, this service data may be data unrelated to the messages of the target session.

The above-mentioned service data may be data of interest to most session users of the target session.

In some embodiments, the service data server may actively generate a session component creation request upon detecting that multiple users in the target session all access a certain piece of service data.

The session component creation request includes a target session identifier and address information of service data. The session component creation request is sent to the session server. The session server creates the target component after receiving the above-mentioned session component creation request. The session server may bind the created target component with the target session identifier.

The above-mentioned target session may be a session indicated by the target session identifier.

In some embodiments, the above-mentioned step S501 includes: in response to receiving a target component creation instruction from a session user of a target session, generating the session component creation request, where the instruction includes the target session identifier and identifier information of the service data.

In these embodiments, the above-mentioned session user may be any session user in the target session.

The session user may issue the above-mentioned target component creation instruction to the service data server. For example, a session user clicks on a control for creating a session component in a session interface to enter a session component creation interface, and then triggers service data (for example, clicking on a display interface corresponding to the service data), so that the above-mentioned operation carries the target session identifier and information of the service data. The client of the session user may generate a target component creation instruction including a target session identifier and information of the service data (e.g., an identifier of the service data). The above-mentioned terminal device then sends the above-mentioned target component creation instruction to the service data server.

In these embodiments, a session user may issue a component creation instruction to create a component for displaying service data according to the requirements, so that the created component has a high degree of matching with the user.

After receiving the above-mentioned target component creation instruction, the service data server determines address information of service data and encapsulates the address information of service data and the target session identifier into a session component creation request.

The service data server may send the above-mentioned session component creation request to a session server (namely, an instant messaging application server) of a target session.

After receiving the above-mentioned session component creation request, the session server may create a target component and then bind the target component to the target session identifier.
S503: sending the service data to the session server; so that the session server generates a target component instance according to the service data.

In some embodiments, the above-mentioned session server may issue a service data acquisition request to the service data server after creating the target component. The above-mentioned service data server may send service data to the session server according to the above-mentioned request.

In some embodiments, the above-mentioned service data server may actively send the above-mentioned service data to the session server.

After receiving the above-mentioned service data, the session server may associate the service data with preset elements of the target component, and then generate rendering information of the target component, thereby generating a target component instance.

In some embodiments, the above-mentioned service data server may also send a display style of the service data to the session server, so that the session server generates a target component instance according to the above-mentioned display style and the above-mentioned service data.

The display style here may be a display style for displaying service data.

The display style herein includes background color, number of windows, window size, window layout, text/symbol color, text/symbol size, font, image/graphic size, etc.

In these embodiments, the above-mentioned service data server provides a display style for displaying service data, so that the session server does not need to determine the display style of the service data, thereby simplifying the step of generating a target component instance by the session server, reducing the resource consumption of generating the target component by the session server, improving the speed of generating the target component by the session server, and further improving the overall efficiency of the process from generating the target component to displaying the target component instance in the session interface of the target session.

In some embodiments, the above-mentioned information processing method further includes:

In response to detecting a change in service data and/or display style, sending change information to the session server, so that the session server updates the target component instance.

In these embodiments, for a target component for which an instance has been generated, the above-mentioned service data server may actively detect whether the service data and/or the display style has been changed, e.g., detecting once every preset time interval.

Upon detecting a change in at least one of the service data and the display style, change information may be generated. The above-mentioned change information includes updating information of describing the service data and/or display style.

In one example, the service data is changed. When it is detected that the service data D1 is changed to the service data D2, change information of a change in the service data is generated. The above-mentioned change information includes description information of the change from service data D1 to service data D2. In this way, after receiving the change information, the session server can replace the service data D1 in the original target component instance with the service data D2, and then send the target component instance with the replaced service data D2 to the client corresponding to the session user; alternatively, instance change information indicating that the service data DI in the target component instance is replaced with the service data D2 is sent to the client corresponding to the target session, so that the above-mentioned client displays the updated target component instance when displaying the above-mentioned target session.

In one example, the display style is changed. When it is detected that the display style, for example, the background color, is changed from C1 to C2, change information is generated. The change information includes description information that the background color is changed from C1 to C2. After receiving the above-mentioned change information, the session server may replace the background color C1 in the original target component instance with the background color C2 and then send the target component instance with the replaced background color to the client of the session user, or send the instance change information indicating that the background color C1 of the target component is replaced with C2 to the client corresponding to the target session, so that the above-mentioned client displays the updated target component instance when displaying the above-mentioned target session.

In these embodiments, by detecting a change in the service data and/or the display style, the change information corresponding to the change is sent to the session server, and the session server updates the target component instance, so that the target component instance displayed in the target session interface can be dynamically updated according to the changes of the service data, and then the user of the target session can learn the latest service data in time in the session interface, and the efficiency for the user to acquire the third-party service data can be further improved.

In some embodiments, the above-mentioned information processing method further includes:
Firstly, receiving an acquisition request for acquiring updating information of service data and/or display style sent by a session server, and detecting whether the service data and/or the display style is updated.
Secondly, in response to detecting that the service data and/or the display style is updated, sending updating information to the session server so that the session server updates the target component instance.

In these embodiments, the service data server may receive the above-mentioned acquisition request sent by the session server and then detect whether the service data and/or the display style is updated. If an update of the service data and/or the display style is detected, updating information is generated. The content included in the updating information herein may refer to the above-mentioned change information actively generated by the service data server.

That is, in these embodiments, the above-mentioned service data server may passively detect whether the service data and/or the display style are updated according to the updating information acquisition request from the session server. It may thus be advantageous for the session server to actively control the updating of the service data and/or the display style. It is further advantageous to control the content in the target component instance displayed in the session interface of the target session.

In these embodiments, the service data server actively or passively detects whether the service data and/or the display style is updated, and sends updating information or change information of the service data and/or the display style to the session server for updating the target component instance, thus it can be ensured that the target component instance can be updated in time, and the target session user can acquire the updated target component instance in time in the session interface.

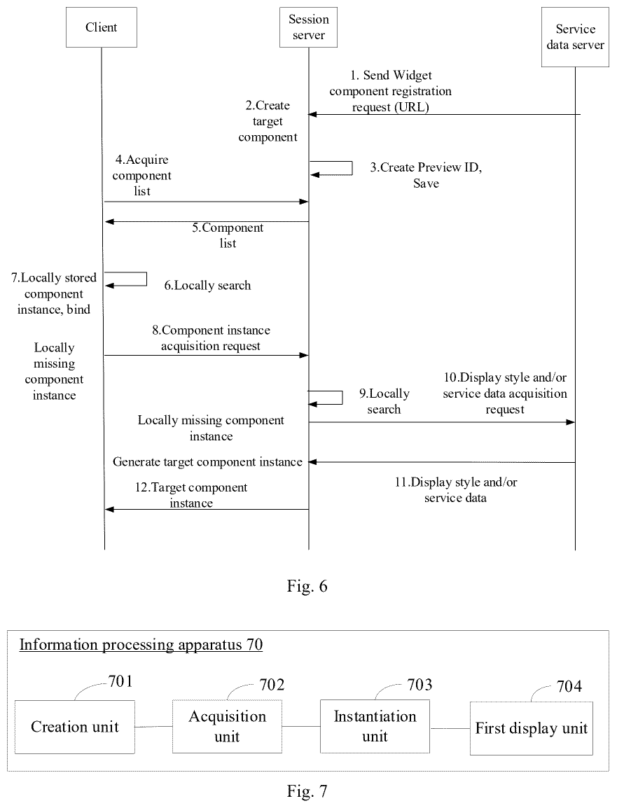

Referring to FIG. 6, a principle flowchart of an information processing method provided in accordance with the present disclosure is shown.

As shown in FIG. 6, step 1, the service data server may send a Widget component registration request to the session server, and the request carries an URL. The registration request may be considered as a session component creation request. Step 2, the session server creates a target component according to the above-mentioned session component creation request. Step 3, the session server creates a preview identifier (PreviewID) of the target component, associates the preview identifier with the above-mentioned URL, and then stores the same. Step 4, a client (e.g., an instant messaging application client) may send a request for acquiring a component list to the session server. Step 5, the session server may send a component list including the preview identifier of the target component to the client. Step 6, after the client receives the component list, for each preview identifier in the component list, the client can find locally whether there is a corresponding component instance. If so, step 7, a target component instance is generated by binding the component instance to the component indicated by the matching preview identifier. For a locally missing component instance (a target component instance), step 8 is performed by the client to send a component instance acquisition request to the session server, where the component instance acquisition request includes a preview identifier of the component. Step 9, after receiving the above-mentioned component instance acquisition request, the session server locally finds a target component instance matching the above-mentioned preview identifier; and if there is such target component instance, step 12 is performed to send the target component instance to the client. When the session server locally misses the target component instance, step 10 is performed to send an acquisition request for display style and/or service data to the service data server. The above-mentioned request includes address information. After receiving the above-mentioned request, the service data server may locally extract the display style and/or service data matching the above-mentioned address information, and then step 11 is performed to send the display style and/or service data matching the address information to the session server, and the session server generates a target component instance according to the target component and the above-mentioned display style and/or service data. The session server then performs step 12 to send the target component instance to the client so that the client displays the target component instance in the display interface of the target session.

FIG. 7 is a block diagram of an information processing apparatus provided by an embodiment of the present disclosure, corresponding to the information processing method of the embodiment shown in FIG. 1 above. For ease of illustration, only those portions related to the embodiments of the present disclosure are shown. Referring to FIG. 7, an apparatus 70 includes: a creation unit 701, an acquisition unit 702, an instantiation unit 703, and a first display unit 704.

The creation unit 701 is configured for creating a target component according to a received session component creation request, where the session component creation request includes a target session identifier and address information of service data.

The acquisition unit 702 is configured for acquiring the service data according to the address information.

The instantiation unit 703 is configured for instantiating a target component according to the service data.

The first display unit 704 is configured for displaying a target component instance in a session interface indicated by the target session identifier.

In some embodiments of the present disclosure, the acquisition unit 702 is further configured for:
acquiring a display style according to the address information; and
the instantiation unit 703 is further configured for:
instantiating the target component based on the display style and the service data.

In some embodiments of the present disclosure, the creation unit 701 is further configured for:
receiving the session component creation request sent by a service data server via a component creation interface; and
creating the target component by using a component addition interface.

In some embodiments of the present disclosure, the creation unit 701 is further configured for:
creating a target component abstraction instance according to the session component creation request.

In some embodiments of the present disclosure, the information processing apparatus 70 further includes an association unit (not shown in the figure) configured for:
creating a preview identifier corresponding to the target component, and associating the preview identifier with the address information; and
sending the preview identifier to a client of a user of the target session, and
the acquisition unit 702 is further configured for:
in response to receiving a browsing request for browsing a target component instance sent by a client of a user of the target session, acquiring the service data according to address information; where the browsing request includes the preview identifier.

In some embodiments of the present disclosure, the information processing apparatus further includes a first update unit (not shown in the figure). The first update unit is configured for:
acquiring updated service data and/or updated display style;
updating the target component instance according to the updated service data and/or updated display style.

In some embodiments of the present disclosure, the information processing apparatus further includes a second update unit (not shown in the figure). The second update unit is configured for:
detecting a change in the target component instance, and pushing information of changed target component instance to the client of the user of the target session; where the change is generated by the updated service data and/or updated display style sent by the service data server.

In some embodiments of the present disclosure, the information processing apparatus further includes a first deletion unit (not shown in the figure). The first deletion unit is configured for:

In response to receiving a deletion instruction for a session component, deleting a component in the target session indicated by the deletion instruction, and sending an instruction for instructing to delete pre-stored information of the component to the client of the target session user.

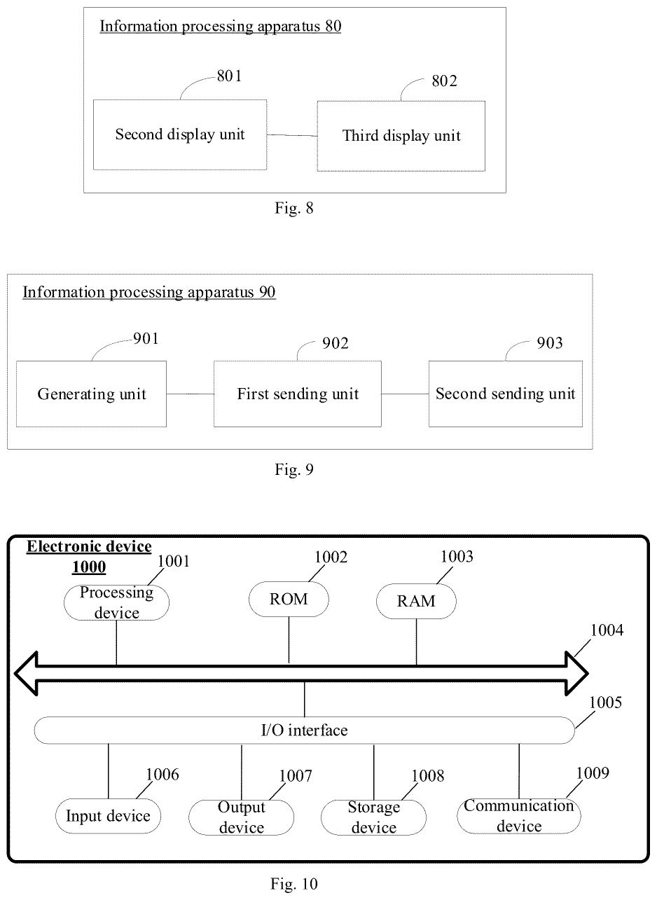

FIG. 8 is a block diagram of a structure of an information processing apparatus provided by an embodiment of the present disclosure, corresponding to the information processing method of the embodiment shown in FIG. 3 above. For ease of illustration, only those portions of the disclosure that are relevant are shown. Referring to FIG. 8, apparatus 80 includes: a second display unit 801 and a third display unit 802. Wherein:

FIG. 8 is a structural block diagram of a text format setting apparatus provided for an embodiment of the present disclosure, corresponding to the information processing method of the above embodiment. For ease of illustration, only those portions related to the embodiments of the present disclosure are shown. Referring to FIG. 8, an apparatus 80 includes: a second display unit 801 and a third display unit 802.

The second display unit 801 is configured for displaying a component container in a session interface of the target session;

The third display unit 802 is configured for displaying at least one component instance including the target component instance in the component container; where the target component instance includes preset service data.

In some embodiments of the present disclosure, the second display unit 801 is further configured for displaying at least part of session message of the target session in the session interface.

In some embodiments of the present disclosure, the component container is displayed at the top of the session interface, and a single component instance is displayed in the component container; and the third display unit 802 is further configured for:
in response to receiving a first display instruction for displaying a plurality of component instances, increasing a display area of the component container in the session interface and displaying the plurality of component instances in the component container.

In some embodiments of the present disclosure, the information processing apparatus further includes a first creation unit (not shown in the figure) configured for:
generating a component creation instruction according to a component creation operation of a user; where the component creation operation is used for creating a target component of a target session, and the component creation instruction includes identifier information of service data and identifier information of the target session;
sending the component creation instruction to a service data server, so that the service data server generates a target component creation request according to the component creation instruction, and sends the target component creation request to a session server so that the session server creates the target component; and
receiving a target component instance sent by the session server, and displaying the target component instance in a session interface of a target session, where the target component instance is generated from the service data acquired by the session server.

In some embodiments of the present disclosure, the information processing apparatus further includes a preview unit (not shown in the figure) configured for:
receiving a preview identifier of the target component sent by the session server, where the above-mentioned preview identifier is generated by the session server when the target component is created; and
in response to detecting that there is no local component instance matched with the preview identifier, sending a request for acquiring a component instance to the session server, receiving a component instance sent by the session server, binding the component instance with the target component, and generating a target component instance; or
in response to detecting that there is a local component instance matched with the preview identifier, binding the component instance with the target component, and generating a target component instance.

In some embodiments of the present disclosure, the information processing apparatus further includes a second deletion unit (not shown in the figure) configured for:
in response to receiving a deletion instruction for deleting a component sent by a user in a target session interface, sending component deletion information for deleting the component indicated by the deletion instruction to the session server; and locally deleting the stored information of the component.

FIG. 9 is a block diagram of a structure of an information processing apparatus provided by an embodiment of the present disclosure, corresponding to the information processing method of the above embodiment. For ease of illustration, only those portions related to the embodiments of the present disclosure are shown. Referring to FIG. 9, an apparatus 90 includes: a generating unit 901, a first sending unit 902, and a second sending unit 903.

The generating unit 901 is configured for generating a session component creation request, where the session component creation request includes address information of service data and a target session identifier.

The first sending unit 902 is configured for sending the session component creation request to a session server of a target session, so that the session server creates a target component.

The second sending unit 903 is configured for sending service data to the session server, so that the session server generates a target component instance according to the service data.

In some embodiments of the present disclosure, the generating unit 901 is further configured for:
generating a component creation request in response to receiving a target component creation instruction from a session user of the target session, where the target component creation instruction includes the target session identifier and identifier information of the service data.

In some embodiments of the present disclosure, the information processing apparatus further includes a third update unit (not shown). The third update unit is configured for:
in response to detecting a change in the service data and/or the display style, sending change information to the session server so that the session server updates the target component instance; or
receiving an acquisition request for acquiring updating information of the service data and/or display style sent by the session server, and detecting whether the service data and/or display style is updated;
in response to the service data and/or display style being updated, sending updating information to the session server so that the session server updates the target component instance.

In order to achieve the above-mentioned embodiments, the embodiments of the present disclosure also provide an electronic device.

Referring to FIG. 10, a block diagram of a structure of an electronic device 1000 suitable for achieving embodiments of the present disclosure is shown. The electronic device 1000 may be a variety of terminal devices, or servers. Here, the terminal device may include, but is not limited to, a mobile terminal such as a mobile phone, a notebook computer, a digital broadcast receiver, a Personal Digital Assistant (PDA), a Portable Android Device (PAD), a Portable Media Player (PMP), an in-vehicle terminal (e.g., an in-vehicle navigation terminal), and the like, and a fixed terminal such as a digital TV, a desktop computer, and the like. The electronic device shown in FIG. 10 is only one example and should not impose any limitation on the functionality and scope of use of embodiments of the present disclosure.

As shown in FIG. 10, the electronic device 1000 may include a processing device (e.g., central processor, graphics processor, etc.) 1001 that may perform various suitable actions and processes in accordance with a program stored in a read-only memory (ROM) 1002 or a program loaded from a storage device 1008 into a random-access memory (RAM) 1003. In the RAM 1003, various programs and data required for the operation of the electronic device 1000 are also stored. The processing device 1001, the ROM 1002, and the RAM 1003 are connected to each other via a bus 1004. An input/output (I/O) interface 1005 is also coupled to the bus 1004.

In general, the following devices may be connected to the I/O interface 1005: an input device 1006 including, for example, a touch screen, a touch pad, a keyboard, a mouse, a camera, a microphone, an accelerometer, a gyroscope, etc.; an output device 1007 including, for example, a Liquid Crystal Display (LCD for short), a speaker, a vibrator, etc.; a storage device 1008 including, for example, a magnetic tape, a hard disk, etc.; and a communication device 1009. The communication device 1009 may allow the electronic device 1000 to have wireless or wired communication with other devices to exchange data. Although FIG. 10 illustrates electronic device 1000 having various devices, it should be understood that not all the illustrated devices are required to be implemented or provided. More or fewer devices may alternatively be implemented or provided.

In particular, processes described herein with reference to flowcharts may be realized in the form of computer software programs in accordance with embodiments of the present disclosure. For example, embodiments of the present disclosure include a computer program product including a computer program embodied on a computer-readable medium, and the computer program includes program codes for performing the methods illustrated in the flowcharts. In such embodiments, the computer program may be downloaded and installed from a network via the communication device 1009, or from the storage device 1008, or from the ROM 1002. The computer program, when executed by the processing device 1001, executes the above-mentioned functions in the methods of the embodiments of the present disclosure.

It should be noted that the computer-readable medium mentioned above in the present disclosure can be a computer-readable signal medium or a computer-readable storage medium or any combination of the two. The computer-readable storage medium can be, for example, but not limited to, an electrical, magnetic, optical, electromagnetic, infrared, or semiconductor system, apparatus or device, or a combination of any of the above. Examples of the computer-readable storage medium may include, but are not limited to, an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium can be any tangible medium containing or storing a program, which can be used by or in combination with an instruction execution system, apparatus or device. In the present disclosure, a computer-readable signal medium may include a data signal propagated in baseband or as part of a carrier wave, in which computer-readable program codes are carried. This propagated data signal can take many forms, including but not limited to electromagnetic signals, optical signals or any suitable combination of the above. A computer-readable signal medium can also be any computer-readable medium other than a computer-readable storage medium, which can send, propagate or transmit a program for use by or in connection with an instruction execution system, apparatus or device. The program codes contained in the computer-readable medium can be transmitted by any suitable medium, including but not limited to: electrical wires, optical cables, RF (radio frequency) and the like, or any suitable combination of the above.

In some embodiments, the client and the server can communicate by using any currently known or future developed network protocol such as HTTP (HyperText Transfer Protocol), and can be interconnected with digital data communication in any form or medium (for example, communication network). Examples of communication networks include a local area network (“LAN”), a wide area network (“WAN”), the Internet (for example, the Internet) and end-to-end networks (for example, ad hoc peer-to-peer networks), as well as any currently known or future developed networks.

The computer-readable medium may be included in the electronic device; or it can exist alone without being assembled into the electronic device.

The computer-readable medium carries one or more programs (computer-executable instructions), which, when executed by the electronic device, enable the electronic device to perform the methods described in the foregoing embodiments.

Computer program codes for performing the operations of the present disclosure may be written in one or more programming languages or their combinations, including but not limited to object-oriented programming languages, such as Java, Smalltalk, C++, and conventional procedural programming languages, such as “C” language or similar programming languages. The program code can be completely executed on the user's computer, partially executed on the user's computer, executed as an independent software package, partially executed on the user's computer and partially executed on a remote computer, or completely executed on a remote computer or server. In the case involving a remote computer, the remote computer may be connected to a user computer through any kind of network, including a local area network (LAN) or a wide area network (WAN), or may be connected to an external computer (for example, through the Internet using an Internet service provider).

The flowcharts and block diagrams in the drawings illustrate the architecture, functions and operations of possible implementations of systems, methods and computer program products according to various embodiments of the present disclosure. In this regard, each block in the flowchart or block diagram may represent a module, a program segment, or a part of code that contains one or more executable instructions for implementing specified logical functions. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions.

The units involved in the embodiments described in the present disclosure can be realized by software or hardware. Among them, the name of the unit does not constitute any limitation of the unit itself in some cases. For example, the creation unit may also be described as “a unit for creating a target component according to a received session component creation request”.

The functions described above herein may be at least partially performed by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of the present disclosure, a machine-readable medium may be a tangible medium that may contain or store a program for use by or in connection with an instruction execution system, apparatus or device. The machine-readable medium may be a machine-readable signal medium or a machine-readable storage medium. A machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more lines, a portable computer disk, a hard disk, a random-access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

The above description only refers to preferred embodiments of the present disclosure and an explanation to the technical principles as used. Those skilled in the art should understand that the scope of disclosure involved in the present disclosure is not limited to the technical solutions formed by the specific combination of the above technical features, and should also cover other technical solutions formed by any combination of the above technical features or their equivalent features without departing from the above disclosure concept. For example, a technical solution formed by replacing the above features with (but not limited to) technical features having similar functions disclosed in the present disclosure.

In addition, although the operations are described in a specific order, this should not be understood as requiring these operations to be performed in the specific order as shown or in a sequential order. Under certain circumstances, multitasking and parallel processing may be advantageous. Similarly, although several specific implementation details are included in the above discussion, these should not be interpreted as limiting the scope of the present disclosure. Certain features that are described in the context of separate embodiments may also be implemented, in combination, in a single embodiment. On the contrary, various features described in the context of a single embodiment may also be implemented in multiple embodiments individually or in any suitable sub-combination.

Although the subject matter has been described in language specific to structural features and/or method logical actions, it should be understood that the subject matter defined in the appended claims is not necessarily limited to the specific features or actions described above. On the contrary, the specific features and actions described above are only example forms for implementing the claims.

1. An information processing method, comprising:
creating a target component according to a received session component creation request, wherein the session component creation request comprises a target session identifier and address information of service data;
acquiring the service data according to the address information;
instantiating the target component according to the service data; and
displaying a target component instance in a session interface indicated by the target session identifier.

2. The method according to claim 1, wherein
the acquiring the service data according to the address information comprises: acquiring a display style according to the address information; and
the instantiating the target component according to the service data comprises: instantiating the target component according to the display style and the service data.

3. The method according to claim 1, wherein the creating a target component according to a received session component creation request comprises:
receiving the session component creation request sent by a service data server through a component creation interface; and
creating the target component by using a component addition interface.

4. The method according to claim 1, wherein the creating a target component according to a received session component creation request comprises:
creating a target component abstraction instance according to the session component creation request.

5. The method according to claim 1, further comprising:
creating a preview identifier corresponding to the target component, and associating the preview identifier with the address information;
sending the preview identifier to a client of a user of a target session; and
the acquiring the service data according to the address information comprises:
in response to receiving a browsing request for browsing the target component instance sent by the client, acquiring the service data according to the address information; wherein the browsing request comprises the preview identifier.

6. The method according to claim 1, further comprising:
acquiring at least one of updated service data and updated display style; and
updating the target component instance according to the at least one of updated service data and updated display style.

7. The method according to claim 1, further comprising:
in response to detecting a change in the target component instance, pushing information of changed target component instance to a client of a user of a target session; wherein the change is generated by at least one of updated service data and updated display style sent by a service data server.

8. The method according to claim 1, further comprising:
in response to receiving a deletion instruction for session component, deleting a component in a target session indicated by the deletion instruction, and sending an instruction for instructing to delete pre-stored information of the component to a client of a user of the target session.

9. An information processing method, comprising:
displaying a component container in a display interface of a target session; and
displaying, in the component container, at least one component instance comprising a target component instance; wherein the target component instance comprises preset service data.

10. The method according to claim 9, further comprising:
generating a component creation instruction according to a component creation operation of a user; wherein the component creation operation is configured to create a target component of the target session, and the component creation instruction comprises identifier information of service data and identifier information of the target session;
sending the component creation instruction to a service data server, so that the service data server generates a target component creation request according to the component creation instruction and sends the target component creation request to a session server, so that the session server creates the target component; and
receiving the target component instance sent by the session server, and displaying the target component instance in the display interface of the target session, wherein the target component instance is generated from service data acquired by the session server.

11. The method according to claim 9, further comprising:
receiving a preview identifier of a target component sent by a session server, wherein the preview identifier is generated by the session server when the session server creates the target component;
in response to detecting that there is no local component instance matched with the preview identifier, sending a request for acquiring a component instance to the session server, and receiving the component instance sent by the session server, binding the component instance with the target component, and generating the target component instance; or
in response to detecting that there is a local component instance matched with the preview identifier, binding the component instance with the target component, and generating the target component instance.

12. The method according to claim 9, further comprising:
in response to receiving an instruction for deleting a component sent by a user in the display interface of the target session, sending component deletion information for deleting the component indicated by the instruction to a session server; and locally deleting stored information of the component.

13. An information processing method, comprising:
generating a session component creation request, wherein the session component creation request comprises address information of service data and a target session identifier;
sending the session component creation request to a session server of a target session, so that the session server creates a target component; and
sending the service data to the session server; so that the session server generates a target component instance according to the service data.

14. The method according to claim 13, wherein the generating a session component creation request comprises:
in response to receiving an instruction for creating the target component sent by a session user of the target session, generating a component creation request, wherein the instruction comprises the target session identifier and identifier information of the service data.

15. The method according to claim 13, further comprising:
in response to detecting a change in at least one of service data and display style, sending change information to the session server so that the session server updates the target component instance;
or,
receiving an acquisition request for acquiring updating information of the at least one of service data and display style sent by the session server, and detecting whether the at least one of service data and display style is updated; and in response to the at least one of service data and display style being updated, sending the updating information to the session server so that the session server updates the target component instance.

16. (canceled)

17. (canceled)

18. The method according to claim 1, implemented by an electronic device comprising a processor and a memory, wherein
the memory is configured to store computer-executable instructions; and
the processor is configured to execute the computer-executable instructions stored in the memory so as to realize steps of the information processing method.

19. The method according to claim 1, implemented by a computer-readable storage medium comprising computer-executable instructions stored thereon, wherein the computer-executable instructions, when executed by a processor, are configured to realize steps of the information processing method.

20. The method according to claim 9, implemented by an electronic device comprising a processor and a memory, wherein
the memory is configured to store computer-executable instructions; and
the processor is configured to execute the computer-executable instructions stored in the memory so as to realize steps of the information processing method.

21. The method according to claim 13, implemented by an electronic device comprising a processor and a memory, wherein
the memory is configured to store computer-executable instructions; and
the processor is configured to execute the computer-executable instructions stored in the memory so as to realize steps of the information processing method.

22. The method according to claim 9, implemented by a computer-readable storage medium comprising computer-executable instructions stored thereon, wherein the computer-executable instructions, when executed by a processor, are configured to realize steps of the information processing method.
